(19) United States
(12) Patent Application Publication
(10) Pub. No.: US 2025/0022220 A1
(43) Pub. Date: Jan. 16, 2025

(54) SENSOR DEVICE AND METHOD FOR OPERATING A SENSOR DEVICE

(71) Applicant: Sony Group Corporation, Tokyo (JP)

(72) Inventors: Diederik Paul MOEYS, Stuttgart (DE); Piergiorgio SARTOR, Stuttgart (DE); Mattia ROSSI, Stuttgart (DE)

(73) Assignee: Sony Group Corporation, Tokyo (JP)

(21) Appl. No.: 18/712,725

(22) PCT Filed: Nov. 10, 2022
(86) PCT No.: PCT/EP2022/081400

§ 371 Date: May 23, 2024

(30) Foreign Application Priority Data
Nov. 30, 2021 (EP) 21211336.9

(51) Int. Cl. G06T 17/00; G06T 5/73; G06T 7/246; G06T 19/20; H04N 23/90

(52) U.S. Cl. CPC G06T 17/00; G06T 5/73; G06T 7/248; G06T 19/20; H04N 23/90; G06T 2200/08; G06T 2207/10024; G06T 2219/2012

(57) ABSTRACT

A three-dimensional scanner system for reconstructing a three-dimensional shape of a moving object comprises a plurality of imaging devices each configured to be focused on the object and each comprising a plurality of imaging pixels each of which being capable to detect a light intensity on the imaging pixel, and to detect as an event a positive or negative change of the light intensity that is larger than a respective predetermined threshold, and a control unit configured to control the plurality of imaging devices and to reconstruct a time series of the three-dimensional shape of the object based on the events detected by the imaging devices and on additional information about colors, shape and/or movements of the object.

### FIELD OF THE INVENTION

The present disclosure relates to a three-dimensional scanner system using event detection sensors such as dynamic vision sensors, DVS, for reconstructing a time series of three-dimensional shapes of a moving object, and a method for operating the same.

### BACKGROUND

Traditional three-dimensional scanning techniques adopt frame-based cameras to capture multiple images of the same object from different perspectives. These images are later matched in order to reconstruct the three-dimensional shape of the object. During the capturing the object must be perfectly still. The use of an array of synchronized cameras can minimize the standing still time, but any subtle movement happening during the camera exposure will inevitably lead to images artifacts (e.g., blur) compromising the image matching phase, hence the accuracy of the reconstruction. This makes traditional three-dimensional scanning techniques not suitable for moving scenarios, such as sport events. Also, the large data quantity resulting from three-dimensional scanning with frame rates known from video image reproduction is also computationally expensive to handle and store.

One approach to this problem is the use of event detection sensors for three-dimensional image reconstruction. Event detection sensors like DVS tackle the problem of motion detection by delivering only information about the position of changes in the imaged scene. Unlike image sensors that transfer large amounts of image information in frames, transfer of information about pixels that do not change may be omitted, resulting in a sort of in-pixel data compression. The in-pixel data compression removes data redundancy and facilitates high temporal resolution, low latency, low power consumption, and high dynamic range with little motion blur. DVS are thus well suited especially to situations were high temporal resolution and low processing latency are demanded, like in the capturing of moving objects. Further, the architecture of DVS allows for high dynamic range and good low-light performance.

The very high temporal resolution of DVS permits to capture fast moving objects, thus permitting reconstruction of a time series of three-dimensional shapes of the object, i.e. a three-dimensional video of the object. Further, high-dynamic range, low-power and low data-rate of the DVS make the overall scanning system more robust and computationally/memory light weight than traditional systems.

However, conventional three-dimensional scanner systems that employ event detection sensors need to track blinking markers attached to the object in focus. Thus, applicability of such scanner systems is limited to prearranged scenes, without the possibility to capture objects without preparation. Further, the scanning results depend strongly on the correct placement of the markers, thus leading to a general error-proneness and inaccuracy of the obtainable results.

It is therefore desirable to further improve three-dimensional shape reconstruction based on event detection sensors like DVS.

### SUMMARY OF INVENTION

To this end, a three-dimensional scanner system for reconstructing a three-dimensional shape of a moving object is provided. The scanner system comprises a plurality of imaging devices each configured to be focused on the object and each comprising a plurality of imaging pixels each of which being capable to detect a light intensity on the imaging pixel, and to detect as an event a positive or negative change of the light intensity that is larger than a respective predetermined threshold. The scanner system comprises further a control unit that is configured to control the plurality of imaging devices and to reconstruct a time series of the three-dimensional shape of the object based on the events detected by the imaging devices and based on additional information about colors, shape and/or movements of the object.

Further, a method for operating a three-dimensional scanner system for reconstructing a three-dimensional shape of a moving object is provided, the scanner system comprising a plurality of imaging devices each comprising a plurality of imaging pixels each of which being capable to detect a light intensity on the imaging pixel, and to detect as an event a positive or negative change of the light intensity that is larger than a respective predetermined threshold. The method comprises: detecting events with the plurality of imaging devices, while focusing the object with the imaging devices; and reconstructing a time series of the three-dimensional shape of the object based on the events detected by the imaging devices and on additional information about colors, shape and/or movements of the object.

Blinking markers, like LED markers, which are used in conventional systems may help to create an easily identifiable event frequency useable for three-dimensional image reconstruction. However, if the markers are set up incorrectly, e.g. if they all blink at the same frequency, further ambiguity regarding the shape to be reconstructed might be generated. To mitigate this problem the present disclosure does not reconstruct three-dimensional shapes based on markers attached to the object of interest. Instead, the event data obtained from the event detection sensors are supplemented with additional information about color, shape, and/or movements of the object that is either known in advance or additionally obtained during the reconstruction process. This additional information helps to match event data obtained when viewing the object with the plurality of imaging devices from different angles such as to allow an accurate reconstruction of the three-dimensional shape of the object without using markers.

### BRIEF DESCRIPTION OF THE DRAWINGS

FIG. 1A is a simplified block diagram of the event detection circuitry of a solid-state imaging device including a pixel array.

FIG. 1B is a simplified block diagram of the pixel array illustrated in FIG. 1A.

FIG. 1C is a simplified block diagram of the imaging signal read-out circuitry of the solid state imaging device of FIG. 1A.

FIGS. 2A and 2B are simplified block diagrams of a three-dimensional scanner system.

FIG. 3 shows schematic diagrams regarding feature matching of images captured by imaging devices of a three-dimensional scanner system.

FIG. 4 is a simplified process flow of a method for operating a three-dimensional scanner system.

### DETAILED DESCRIPTION

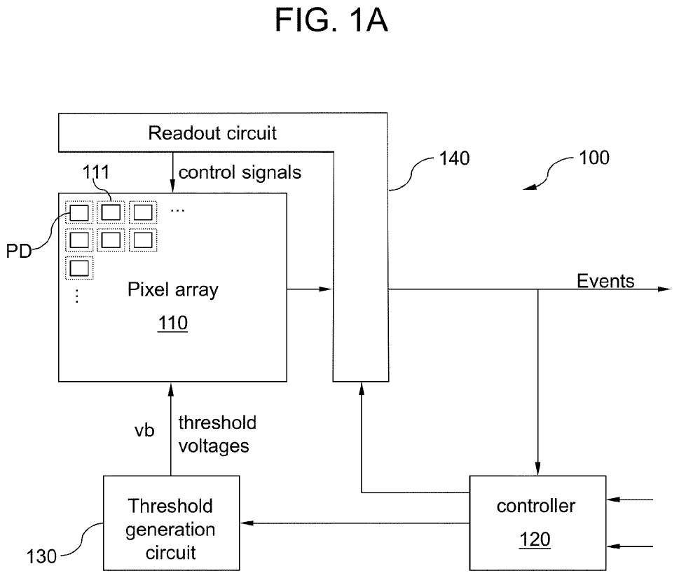

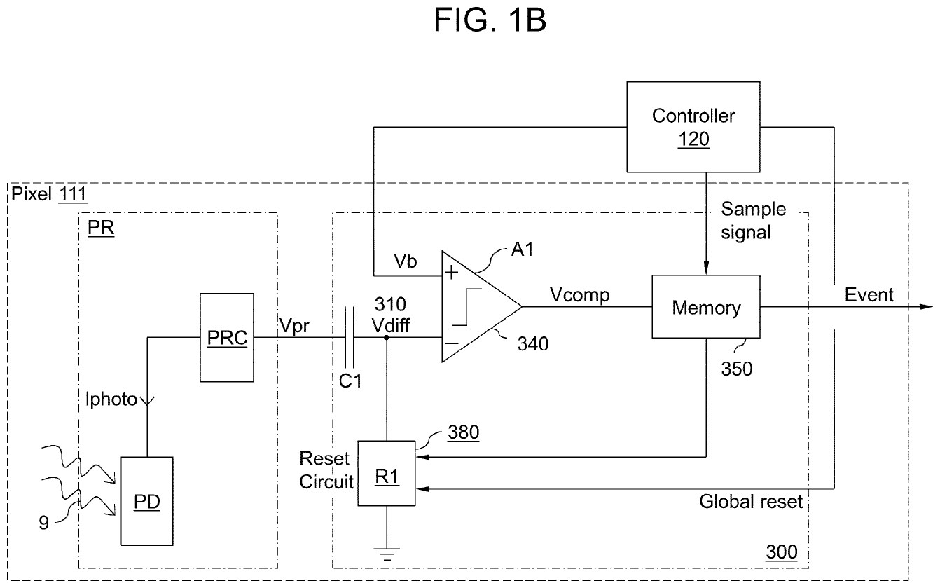

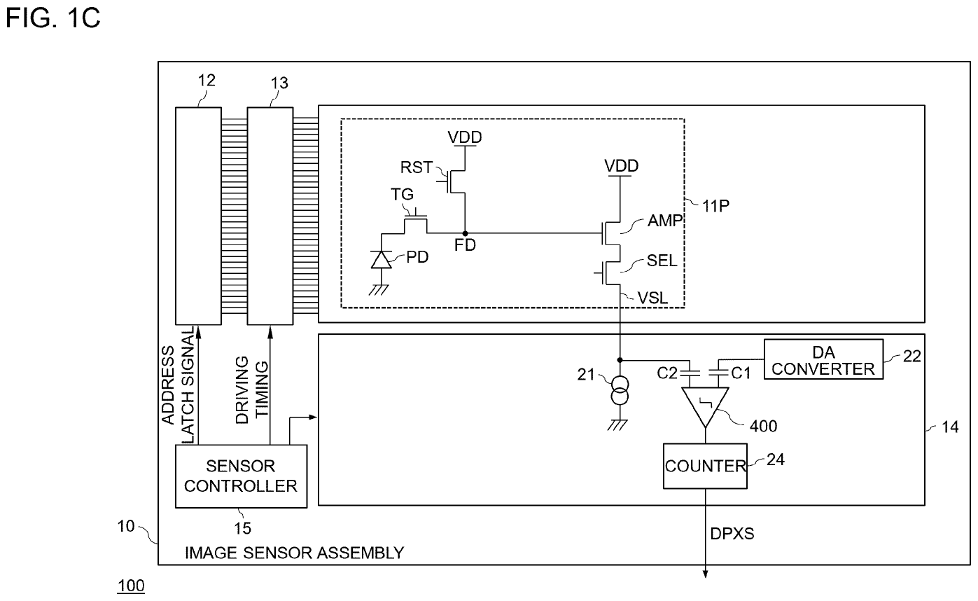

The following description of a three-dimensional scanner system is based on the usage of event vision sensors, EVS, also known as dynamic vision sensors, DVS. Although the principle functioning of such solid state imaging devices is known to a skilled person, it will be recapitulated in the following with respect to FIGS. 1A to 1C.

FIG. 1A is a block diagram of a solid-state imaging device 100 employing event based change detection. The solid-state imaging device 100 includes a pixel array 110 with one or more imaging pixels 111, wherein each pixel 111 includes a photoelectric conversion element PD. The pixel array 110 may be a one-dimensional pixel array with the photoelectric conversion elements PD of all pixels arranged along a straight or meandering line (line sensor). In particular, the pixel array 110 may be a two-dimensional array, wherein the photoelectric conversion elements PDs of the pixels 111 may be arranged along straight or meandering rows and along straight or meandering lines.

The illustrated embodiment shows a two dimensional array of pixels 111, wherein the pixels 111 are arranged along straight rows and along straight columns running orthogonal the rows. Each pixel 111 converts incoming light into an imaging signal representing the incoming light intensity and an event signal indicating a change of the light intensity, e.g. an increase by at least an upper threshold amount and/or a decrease by at least a lower threshold amount. If necessary, the function of each pixel 111 regarding intensity and event detection may be divided and different pixels observing the same solid angle can implement the respective functions. These different pixels may be subpixels and can be implemented such that they share part of the circuitry. The different pixels may also be part of different image sensors. For the present disclosure, whenever it is referred to a pixel capable of generating an imaging signal and an event signal, this should be understood to include also a combination of pixels separately carrying out these functions as described above.

A controller 120 performs a flow control of the processes in the pixel array 110. For example, the controller 120 may control a threshold generation circuit 130 that determines and supplies thresholds to individual pixels 111 in the pixel array 110. A readout circuit 140 provides control signals for addressing individual pixels 111 and outputs information about the position of such pixels 111 that indicate an event. Since the solid-state imaging device 100 employs event-based change detection, the readout circuit 140 may output a variable amount of data per time unit.

FIG. 1B shows exemplarily details of the imaging pixels 111 in FIG. 1A as far as their event detection capabilities are concerned. Of course, any other implementation that allows detection of events can be employed. Each pixel 111 includes a photoreceptor module PR and is assigned to a pixel back-end 300, wherein each complete pixel back-end 300 may be assigned to one single photoreceptor module PR. Alternatively, a pixel back-end 300 or parts thereof may be assigned to two or more photoreceptor modules PR, wherein the shared portion of the pixel back-end 300 may be sequentially connected to the assigned photoreceptor modules PR in a multiplexed manner.

The photoreceptor module PR includes a photoelectric conversion element PD, e.g. a photodiode or another type of photosensor. The photoelectric conversion element PD converts impinging light 9 into a photocurrent Iphoto through the photoelectric conversion element PD, wherein the amount of the photocurrent Iphoto is a function of the light intensity of the impinging light 9.

A photoreceptor circuit PRC converts the photocurrent Iphoto into a photoreceptor signal Vpr. The voltage of the photoreceptor signal Vpr is a function of the photocurrent Iphoto.

A memory capacitor 310 stores electric charge and holds a memory voltage which amount depends on a past photoreceptor signal Vpr. In particular, the memory capacitor 310 receives the photoreceptor signal Vpr such that a first electrode of the memory capacitor 310 carries a charge that is responsive to the photoreceptor signal Vpr and thus the light received by the photoelectric conversion element PD. A second electrode of the memory capacitor C1 is connected to the comparator node (inverting input) of a comparator circuit 340. Thus the voltage of the comparator node, Vdiff varies with changes in the photoreceptor signal Vpr.

The comparator circuit 340 compares the difference between the current photoreceptor signal Vpr and the past photoreceptor signal to a threshold. The comparator circuit 340 can be in each pixel back-end 300, or shared between a subset (for example a column) of pixels. According to an example each pixel 111 includes a pixel back-end 300 including a comparator circuit 340, such that the comparator circuit 340 is integral to the imaging pixel 111 and each imaging pixel 111 has a dedicated comparator circuit 340.

A memory element 350 stores the comparator output in response to a sample signal from the controller 120. The memory element 350 may include a sampling circuit (for example a switch and a parasitic or explicit capacitor) and/or a digital memory circuit such as a latch or a flip-flop). In one embodiment, the memory element 350 may be a sampling circuit. The memory element 350 may be configured to store one, two or more binary bits.

An output signal of a reset circuit 380 may set the inverting input of the comparator circuit 340 to a predefined potential. The output signal of the reset circuit 380 may be controlled in response to the content of the memory element 350 and/or in response to a global reset signal received from the controller 120.

The solid-state imaging device 100 is operated as follows: A change in light intensity of incident radiation 9 translates into a change of the photoreceptor signal Vpr. At times designated by the controller 120, the comparator circuit 340 compares Vdiff at the inverting input (comparator node) to a threshold Vb applied on its non-inverting input. At the same time, the controller 120 operates the memory element 350 to store the comparator output signal Vcomp. The memory element 350 may be located in either the pixel circuit 111 or in the readout circuit 140 shown in FIG. 1A.

If the state of the stored comparator output signal indicates a change in light intensity AND the global reset signal GlobalReset (controlled by the controller 120) is active, the conditional reset circuit 380 outputs a reset output signal that resets Vdiff to a known level.

The memory element 350 may include information indicating a change of the light intensity detected by the pixel 111 by more than a threshold value.

The solid state imaging device 120 may output the addresses (where the address of a pixel 111 corresponds to its row and column number) of those pixels 111 where a light intensity change has been detected. A detected light intensity change at a given pixel is called an event. More specifically, the term ‘event’ means that the photoreceptor signal representing and being a function of light intensity of a pixel has changed by an amount greater than or equal to a threshold applied by the controller through the threshold generation circuit 130. To transmit an event, the address of the corresponding pixel 111 is transmitted along with data indicating whether the light intensity change was positive or negative. The data indicating whether the light intensity change was positive or negative may include one single bit.

To detect light intensity changes between current and previous instances in time, each pixel 111 stores a representation of the light intensity at the previous instance in time.

More concretely, each pixel 111 stores a voltage Vdiff representing the difference between the photoreceptor signal at the time of the last event registered at the concerned pixel 111 and the current photoreceptor signal at this pixel 111.

To detect events, Vdiff at the comparator node may be first compared to a first threshold to detect an increase in light intensity (ON-event), and the comparator output is sampled on a (explicit or parasitic) capacitor or stored in a flip-flop. Then Vdiff at the comparator node is compared to a second threshold to detect a decrease in light intensity (OFF-event) and the comparator output is sampled on a (explicit or parasitic) capacitor or stored in a flip-flop.

The global reset signal is sent to all pixels 111, and in each pixel 111 this global reset signal is logically ANDed with the sampled comparator outputs to reset only those pixels where an event has been detected. Then the sampled comparator output voltages are read out, and the corresponding pixel addresses sent to a data receiving device.

FIG. 1C illustrates a configuration example of the solid-state imaging device 100 including an image sensor assembly 10 that is used for readout of intensity imaging signals in form of an active pixel sensor, APS. Here, FIG. 1C is purely exemplary. Readout of imaging signals can also be implemented in any other known manner. As stated above, the image sensor assembly 10 may use the same pixels 111 or may supplement these pixels 111 with additional pixels observing the respective same solid angles. In the following description the exemplary case of usage of the same pixel array 110 is chosen.

The image sensor assembly 10 includes the pixel array 110, an address decoder 12, a pixel timing driving unit 13, an ADC (analog-to-digital converter) 14, and a sensor controller 15.

The pixel array 110 includes a plurality of pixel circuits 11P arranged matrix-like in rows and columns. Each pixel circuit 11P includes a photosensitive element and FETs (field effect transistors) for controlling the signal output by the photosensitive element.

The address decoder 12 and the pixel timing driving unit 13 control driving of each pixel circuit 11P disposed in the pixel array 110. That is, the address decoder 12 supplies a control signal for designating the pixel circuit 11P to be driven or the like to the pixel timing driving unit 13 according to an address, a latch signal, and the like supplied from the sensor controller 15. The pixel timing driving unit 13 drives the FETs of the pixel circuit 11P according to driving timing signals supplied from the sensor controller 15 and the control signal supplied from the address decoder 12. The electric signals of the pixel circuits 11P (pixel output signals, imaging signals) are supplied through vertical signal lines VSL to ADCs 14, wherein each ADC 14 is connected to one of the vertical signal lines VSL, and wherein each vertical signal line VSL is connected to all pixel circuits 11P of one column of the pixel array unit 11. Each ADC 14 performs an analog-to-digital conversion on the pixel output signals successively output from the column of the pixel array unit 11 and outputs the digital pixel data DPXS to the signal processing unit 19. To this purpose, each ADC 14 includes a comparator 23, a digital-to-analog converter (DAC) 22 and a counter 24.

The sensor controller 15 controls the image sensor assembly 10. That is, for example, the sensor controller 15 supplies the address and the latch signal to the address decoder 12, and supplies the driving timing signal to the pixel timing driving unit 13. In addition, the sensor controller 15 may supply a control signal for controlling the ADC 14.

The pixel circuit 11P includes the photoelectric conversion element PD as the photosensitive element. The photoelectric conversion element PD may include or may be composed of, for example, a photodiode. With respect to one photoelectric conversion element PD, the pixel circuit 11P may have four FETs serving as active elements, i.e., a transfer transistor TG, a reset transistor RST, an amplification transistor AMP, and a selection transistor SEL.

The photoelectric conversion element PD photoelectrically converts incident light into electric charges (here, electrons). The amount of electric charge generated in the photoelectric conversion element PD corresponds to the amount of the incident light.

The transfer transistor TG is connected between the photoelectric conversion element PD and a floating diffusion region FD. The transfer transistor TG serves as a transfer element for transferring charge from the photoelectric conversion element PD to the floating diffusion region FD. The floating diffusion region FD serves as temporary local charge storage. A transfer signal serving as a control signal is supplied to the gate (transfer gate) of the transfer transistor TG through a transfer control line.

Thus, the transfer transistor TG may transfer electrons photoelectrically converted by the photoelectric conversion element PD to the floating diffusion FD.

The reset transistor RST is connected between the floating diffusion FD and a power supply line to which a positive supply voltage VDD is supplied. A reset signal serving as a control signal is supplied to the gate of the reset transistor RST through a reset control line.

Thus, the reset transistor RST serving as a reset element resets a potential of the floating diffusion FD to that of the power supply line.

The floating diffusion FD is connected to the gate of the amplification transistor AMP serving as an amplification element. That is, the floating diffusion FD functions as the input node of the amplification transistor AMP serving as an amplification element.

The amplification transistor AMP and the selection transistor SEL are connected in series between the power supply line VDD and a vertical signal line VSL.

Thus, the amplification transistor AMP is connected to the signal line VSL through the selection transistor SEL and constitutes a source-follower circuit with a constant current source 21 illustrated as part of the ADC 14.

Then, a selection signal serving as a control signal corresponding to an address signal is supplied to the gate of the selection transistor SEL through a selection control line, and the selection transistor SEL is turned on.

When the selection transistor SEL is turned on, the amplification transistor AMP amplifies the potential of the floating diffusion FD and outputs a voltage corresponding to the potential of the floating diffusion FD to the signal line VSL. The signal line VSL transfers the pixel output signal from the pixel circuit 11P to the ADC 14.

Since the respective gates of the transfer transistor TG, the reset transistor RST, and the selection transistor SEL are, for example, connected in units of rows, these operations are simultaneously performed for each of the pixel circuits 11P of one row. Further, it is also possible to selectively read out single pixels or pixel groups.

The ADC 14 may include a DAC 22, the constant current source 21 connected to the vertical signal line VSL, a comparator 23, and a counter 24.

The vertical signal line VSL, the constant current source 21 and the amplifier transistor AMP of the pixel circuit 11P combine to a source follower circuit.

The DAC 22 generates and outputs a reference signal. By performing digital-to-analog conversion of a digital signal increased in regular intervals, e.g. by one, the DAC 22 may generate a reference signal including a reference voltage ramp. Within the voltage ramp, the reference signal steadily increases per time unit. The increase may be linear or not linear.

The comparator 23 has two input terminals. The reference signal output from the DAC 22 is supplied to a first input terminal of the comparator 23 through a first capacitor C1. The pixel output signal transmitted through the vertical signal line VSL is supplied to the second input terminal of the comparator 23 through a second capacitor C2.

The comparator 23 compares the pixel output signal and the reference signal that are supplied to the two input terminals with each other, and outputs a comparator output signal representing the comparison result. That is, the comparator 23 outputs the comparator output signal representing the magnitude relationship between the pixel output signal and the reference signal. For example, the comparator output signal may have high level when the pixel output signal is higher than the reference signal and may have low level otherwise, or vice versa. The comparator output signal VCO is supplied to the counter 24.

The counter 24 counts a count value in synchronization with a predetermined clock. That is, the counter 24 starts the count of the count value from the start of a P phase or a D phase when the DAC 22 starts to decrease the reference signal, and counts the count value until the magnitude relationship between the pixel output signal and the reference signal changes and the comparator output signal is inverted. When the comparator output signal is inverted, the counter 24 stops the count of the count value and outputs the count value at that time as the AD conversion result (digital pixel data DPXS) of the pixel output signal.

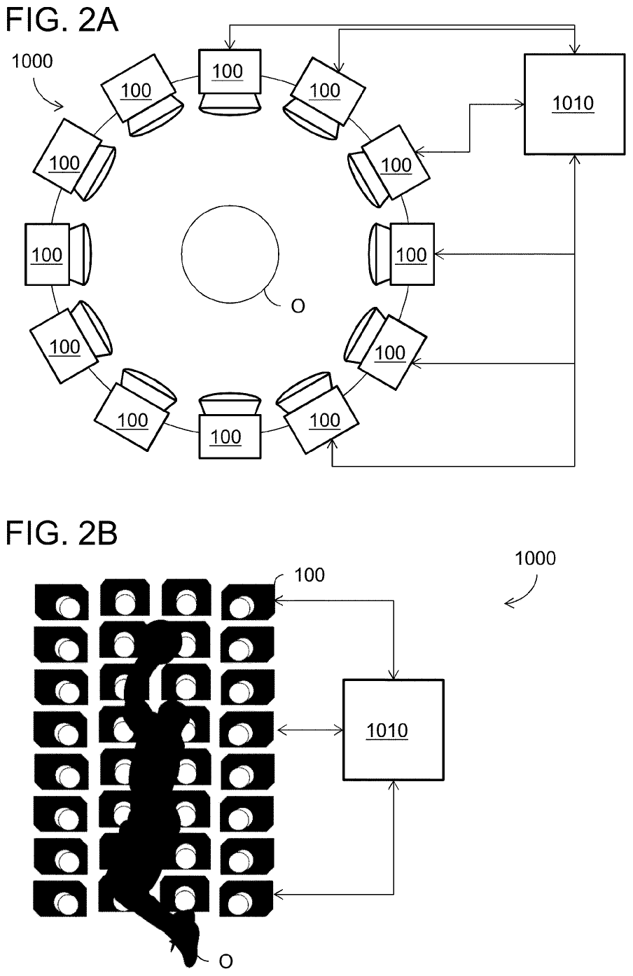

FIGS. 2A and 2B are simplified and schematic block diagrams of three-dimensional scanner systems 1000 for reconstructing a three-dimensional shape of a moving object O. The scanner system 1000 comprises a plurality of imaging devices 100 that are focused each on the object O and comprise each a plurality of imaging pixels 111 each of which being capable to detect a light intensity on the imaging pixel 111, and to detect as an event a positive or negative change of the light intensity that is larger than a respective predetermined threshold. This means the scanner system comprises a plurality of DVS/EVS that are constituted by imaging devices 100 as described above with respect to FIG. 1A. The imaging devices 100 capture continuously, and preferably in synchronization, images of the object O from different perspectives. Exemplary, FIG. 2A shows a cylindrical setup of imaging devices 100 surrounding object O, while FIG. 2B shows a wall of imaging devices 100, each focusing on moving object O. Of course, any other arrangement of sensor devices 100 is possible, as long as the object O is captured from different perspectives.

The scanner system 1000 further comprises a control unit 1010 configured to control the plurality of imaging devices 100 and to reconstruct a time series of the three-dimensional shape of the object O based on the events detected by the imaging devices 100 and on additional information about colors, shape and/or movements of the object O.

The control unit 1010 may read out the events detected by the imaging pixels 111, either in real time or repeatedly after given time periods, such as e.g. periodically. The control unit 1010 may be any kind of processor, circuitry, hardware or software capable of reading out the events. The control unit 1010 may be formed as a single chip with the rest of the circuitry of one of the imaging devices 100 or may be a separate chip or computer. The control unit 1010 and the imaging pixels 111 may also be (at least partly) formed by the same components. In this sense the control unit 1010 may also be distributed over several imaging devices 100. The control unit 1010 is configured to perform processing on the detected event data to reconstruct the three-dimensional shape of the object O from the event data. To this end the control unit may use artificial intelligence systems. Further, the control unit is capable to control the overall functioning of the imaging devices 100.

Due to usage of DVS/EVS the constraint of regular frame-based approaches to static subject/scene reconstruction in specific lighting conditions can be avoided. Instead, the advantages of the DVS technology can be exploited. In particular, a continuous stream of three-dimensional shapes of object O at different instances in time can be obtained with low latency (orders of microseconds) and without integration time, which allows reconstruction of three-dimensional moving objects with high fidelity. Further, high dynamic range is provided, which permits reconstructing the shape of three-dimensional objects in adverse lighting conditions. Also, DVS require only comparably low-power, which permits designing a reasonably powered system. Finally, a DVS has comparably low data-rate, which reduces the large amount of data coming out of a conventional scanner, when it is applied to a moving object.

The scanner system 1000/the control unit 1010 may be configured to operate based on the following algorithm. The imaging devices 100 continuously record the moving object O, respectively the scene in which it is moving, preferably in a synchronized manner. Each of the imaging devices 100 detects a series of events and if needed intensity and/or color information. From the event distributions obtained during a predetermined time period key features can then be extracted such as e.g. corners, edges, points of high contrast, or the like.

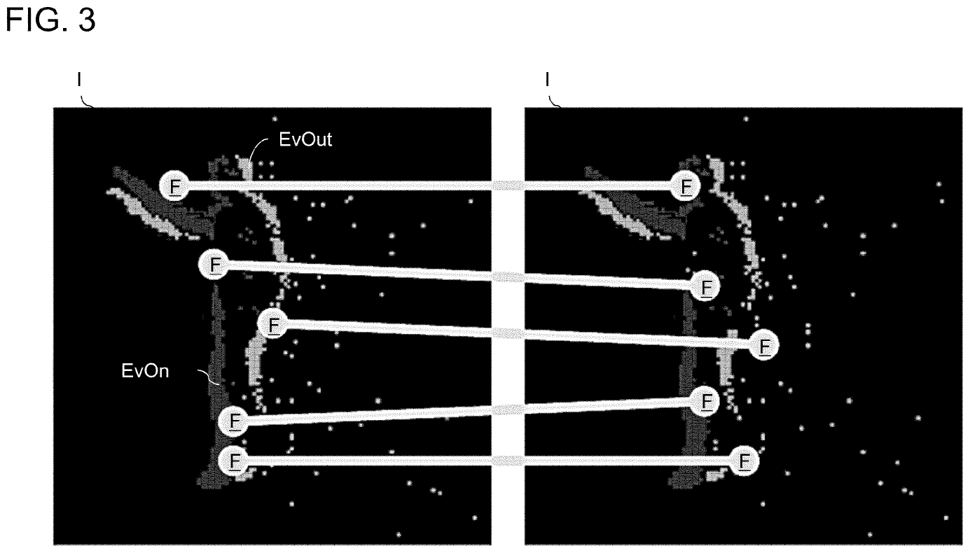

The extracted features can be matched across the various recordings of the plurality of imaging devices (see also FIG. 3 described below). Matching features may be found either by machine learning algorithms or by rule-based algorithms operating on a variety of event representations such as e.g. images comprising the sum of N events, images comprising the sum of all events happening in a predefined time, surfaces of active events (consisting of the last event timestamps), or the like. Additional information for discriminating features is used to improve this matching step.

Possible candidates for such additional information may be color information, if some imaging sensors are color sensors or if data obtained by color sensors are available. Further, the density (rough number of events in space and time) of a specific color event channel produced by a colored feature can be used to match event/imaging data of different imaging devices 100. Similarly, pixel-wise information on polarization or the like may be used. As a further example, gradient information in time vs x/y coordinates created by the moving features of the object O could be used as additional information for improved matching (if a feature moves up, and one down, they should not be matched together). Similarly, one might use direction, speed, or acceleration of the optic flow captured by different imaging devices as a discriminant for matching.

The above described improved feature matching process allows reconstructing a three-dimensional model of the object O at all moments in time. Further motion analysis may be performed based on the generated three dimensional model, or the model may be further modified, e.g. by adding texture, color, additional features, or the like, for application specific purposes.

In this process merging with conventional active pixel sensor, APS, data can be performed. To this end, a regular frame-based APS as described above with respect to FIG. 1C might be used that is looking at the same scene. Just the same, a hybrid DVS/APS may be used, i.e. the APS might be formed by one of the imaging devices 100 that has also the capability to capture intensity/color frames. The color information (e.g. red-green-blue, RGB, or any other color information) can be merged with the three-dimensional model obtained from the event data. For example, semantic segmentation from the APS images can be used to improve the feature-matching operation, to add color information to the three-dimensional model periodically or at the start during low-motion moments (low event rate detected), or to deblur or interpolate blurred color frames with DVS data and to reconstruct the three-dimensional shapes then based on the improved, high-resolution APS images.

In the above method it is not necessary to prepare the monitored moving object O before performing the three-dimensional scan, e.g. by markers attached to the object O such as blinking LED markers. Accordingly, the problem is solved of how to obtain an accurate reconstruction of the three-dimensional shape of an object without using markers.

The control unit 1010 is configured to generate for each imaging device 100 a two-dimensional image I showing the events detected by the respective imaging device 100 during a predetermined time period, to extract key features F from the two-dimensional images I captured by all imaging devices 100 during the predetermined time period, and to perform feature matching between the extracted key features F, in order to reconstruct the three-dimensional shape the object had during the predetermined time period. To support the process of feature matching, the control unit 1010 is configured to use the additional information.

FIG. 3 shows exemplary two images I obtained from two of the imaging devices 100 that are obtained by marking all imaging pixels 111 that detected an event during a predetermined time period. Dark grey pixels “EvOn” show events with positive polarity, i.e. imaging pixels 111 where the received intensity increased sufficiently, while light grey events “EvOut” show events with negative polarity, i.e. imaging pixels 111 where the received intensity decreased sufficiently. From the ON- and OFF-events it can be understood that the two images I show a person moving forward and raising one of its arms.

In the images I key features F can be identified and matched with each other as shown exemplary in FIG. 3. Conventionally, this is done by fixing markers to the monitored object, e.g. by fixing markers to the clothes of a person or by letting the person wear belts, straps or the like holding the markers. However, by using additional information on the colors, shape and/or movements of the object O, it is possible to supplement the event data with external data that allows identifying a sufficient amount of key features that allows reconstruction of the three-dimensional shape of the object O at any time without the use of markers.

Additional information may e.g. be light intensities of visible light in different color channels obtained by imaging devices 100 capable to detect such intensities. These might e.g. at least partially be the same imaging devices 100 that are capable to detect events. But also additional imaging devices may be used. The color information can e.g. be used to obtain a principle alignment of different event images I as shown in FIG. 3 by focusing on predominant color changes visible in a scene. Although possibly blurred due to the movement of the object O such color changes can nevertheless serve to preprocess (e.g. rotate, scale or the like) event images I such as to ease feature matching between these images.

The additional information on light intensities may also be used to add color information on the three-dimensional shape reconstructed from the detected events. This helps to create from the in principle colorless event data a realistic three-dimensional model of the object O that resembles the object O also in color.

The additional information on light intensities may alternatively or additionally also comprise a time series of color frame images of the moving object O, i.e. a video stream of full color frames can be obtained that shows the object O from different perspectives. The control unit 1010 is then configured to improve the time series of color frame images by removing blur from the color frame images or by interpolating the color frame images based on the detected events, and to reconstruct the time series of the three-dimensional shape of the object O from the improved time series of color frame images. Thus, instead of supplementing the event images I with color information, the control unit 1010 may instead or additionally supplement full color frame images with the event data.

Here, the color images are possibly blurred due to the comparably low time resolution of the color images. By using the event data that allow deducing e.g. which part of the object entered which part of space at which instance of time, it is possible to pin blurred pieces of the color images to a specific location in the image and deblur the color images in this manner. Further, since the temporal resolution of the event stream is much higher than the temporal resolution of the color image stream, it is possible to generate a series of color images by processing a single image that was actually captured. In this manner a stream of color images with temporal resolution comparable to the temporal resolution of the event stream can be generated that interpolates between the actually captured color images.

From this temporally highly resolved color image stream it is then possible to generate a time series of fully colored three-dimensional shapes of the observed object O.

The imaging pixels 111 of the imaging devices 100 may be capable to group the detected events according to characteristics of the received light, wherein the additional information comprises then information on the spatial and/or temporal distribution of events generated by light of a given characteristic. For example, if the imaging pixels 111 of the imaging devices 100 are capable to detect events as well as light intensities of different color channels, the given characteristic may be the color of the received light, i.e. the detected events can be grouped according to the color the light had that caused them. This will ease feature matching, since only events matching in color (e.g. red, green or blue color channel) are possible candidates for a feature matching. Colored events may e.g. be produced by using respective color filters in the imaging devices 100.

As a further example, if the imaging pixels 111 are capable to group the detected events according to the polarization of the received light, the given characteristics may be the polarization of the received light. Just as in the case of “colored events”, polarization filters within the imaging devices 100 may allow to separate between events that are caused by light of different polarization. Also in this manner, sources of the light received from the object O may be clearly distinguished to simplify the feature matching.

Of course also other characteristics of the received light (like e.g. absolute intensity) may be used to make a preselection of in principle matchable events. Further, different characteristics may be combined to refine the event grouping.

Additionally or alternatively, the control unit 1010 may be configured to deduce for each imaging device from changes in the distribution of detected events over time directions of movements of the object. Then, the additional information may comprise the directions of movements of the object as deduced for at least a part of the imaging devices. As explained with respect to FIG. 3, event images I allow in principle to deduce the direction of movements of the object O (or its parts) from a comparison of positive and negative polarity events. This information can be used to preselect events for feature matching, since (for accordingly aligned imaging devices 100) only events in different images showing the same direction of movement can be related to the same part of the object O.

Just the same, the imaging devices 100 may be capable to capture an optic flow, i.e. to determine movements within the imaged scene as seen when projected to the two-dimensional imaging plane. Then, the additional information may additionally or alternatively comprise direction, speed, and acceleration of the optic flow. This eases feature matching, since only events of image parts that “flow” in the same direction with a comparable speed and acceleration are candidates for feature matching.

Additionally or alternatively, the additional information may comprise a previously generated high resolution model of the three-dimensional shape of the object O at rest. The control unit 1010 may then be configured to reconstruct the three-dimensional shape of the object from the detected events with a spatial resolution that is lower than the spatial resolution of the high resolution model, and to fit the high resolution model to the three-dimensional shapes reconstructed from the detected events in order to increase the spatial resolution of these three-dimensional shapes.

In this scenario the control unit 1010 basically knows the shape of the object in a given posture. The event data are then used to create a rough estimate on the present posture that will be supplemented by the precise knowledge about the object's O features available from the pre-generated high resolution model. This eases feature matching, since features need only be matched until a sufficiently detailed three dimensional model can be reconstructed that can serve as basis for fitting the high resolution model to it.

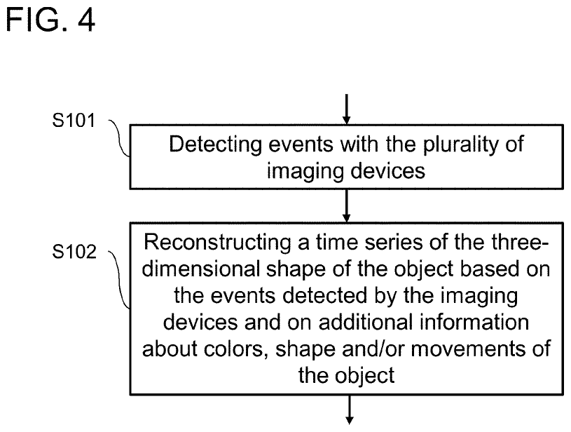

Thus, as explained above, various types of additional information can be used alone or in combination to improve the accuracy of an event based three dimensional model of a moving object without the need to have markers on the object. The principle steps of this process are exemplified in FIG. 4: At step S101 events are detected with a plurality of imaging devices 100 of a scanner system 1000 as described above, while focusing the imaging devices 100 on an object O. At S102 a time series of the three-dimensional shape of the object O is reconstructed based on the events detected by the imaging devices 100 and on additional information about colors, shape and/or movements of the object O.

Possible applications of the scanner system 1000 described above may be athlete body tracking for the purpose of teaching, performance evaluation/improvement over time. Here, a previously-scanned accurate three dimensional model of the athlete (acquired with a conventional setup and frame-based cameras) could be fitted to the less accurate DVS reconstructed three dimensional model through an optimization process. The model could also be parametrized and its parameters regressed for best match.

Further, still in the context of sports, the setup could also be tracking of simpler objects such as a ball or sports equipment critical to the game (such as hockey sticks or the like) in order to compile game statistics and detect foul play.

In the game/movie industry, the real-time and free-body three dimensional tracking of one or more real actors described above can be used to drive the three dimensional models of artificial characters. There will no longer be the need for trackers or markers attached to the body of the actor in order to track a simplified version of its body pose and then transfer it to the complex three dimensional model of the artificial character.

The three dimensional scanner system 1000 may also be used for transmission of holograms for teleportation with low bandwidth. The three-dimensional model of the speaker could be pre-reconstructed with high resolution and sent to the receiver side. Then the proposed DVS-based scanning system could be used to capture the sender body changes and transmit only these to the receiver, where the pre-reconstructed model would be compensated in real-time, thus avoiding to send the whole model continuously.

Further, the fast tracking capabilities of the proposed system could be used in augmented or virtual reality scenarios to, for example, project texture and clothes to the tracked human body.

Also, industrial high-speed inspection can be improved by the scanner system 1000. For example, the setup could be used on a conveyor belt running at high-speed for defect inspection. A known model could be fitted also to the object to estimate deviation from the ideal shape.

Embodiments of the present technology are not limited to the above-described embodiments, but various changes can be made within the scope of the present technology without departing from the gist of the present technology.

Note that the present technology can also be configured as described below:
(1) A three-dimensional scanner system for reconstructing a three-dimensional shape of a moving object, the scanner system comprising:
   a plurality of imaging devices each configured to be focused on the object and each comprising a plurality of imaging pixels each of which being capable to detect a light intensity on the imaging pixel, and to detect as an event a positive or negative change of the light intensity that is larger than a respective predetermined threshold; and
   a control unit configured to control the plurality of imaging devices and to reconstruct a time series of the three-dimensional shape of the object based on the events detected by the imaging devices and on additional information about colors, shape and/or movements of the object.
(2) The sensor system according to (1), wherein
   the control unit is configured to generate for each imaging device a two-dimensional image showing the events detected by the respective imaging device during a predetermined time period, to extract key features from the two-dimensional images captured by all imaging devices during the predetermined time period, and to perform feature matching between the extracted key features, in order to reconstruct the three-dimensional shape the object had during the predetermined time period; and
   the control unit is configured to use the additional information to support the process of feature matching.
(3) The scanner system according to (1) or (2), further comprising
   imaging devices that are capable to detect light intensities of visible light in different color channels in order to generate the additional information.
(4) The scanner system according (3), wherein
   additional information comprises used to add color information on the three-dimensional shape reconstructed from the detected events.
(5) The scanner system according (3), wherein
   the additional information comprises a time series of color frame images of the moving object; and
   the control unit is configured improve the time series of color frame images by removing blur from the color frame images or by interpolating the color frame images based on the detected events, and to reconstruct the time series of the three-dimensional shape of the object from the improved time series of color frame images.
(6) The scanner system according to any one of (1) to (5), wherein
   the imaging pixels are capable to group the detected events according to characteristics of the received light, and
   the additional information comprises information on the spatial and/or temporal distribution of events generated by light of a given characteristic.
(7) The scanner system according to (6), wherein
   the same imaging pixels are capable to detect events and to detect light intensities of different color channels; and
   the given characteristic is the color of the received light.
(8) The scanner system according to (6), wherein the imaging pixels are capable to group the detected events according to the polarization of the received light; and the given characteristics is the polarization of the received light.
(9) The scanner system according to any one of (1) to (8), wherein
   the control unit is configured to deduce for each imaging device from changes in the distribution of detected events over time directions of movements of the object; and
   the additional information comprises the directions of movements of the object as deduced for at least a part of the imaging devices.
(10) The scanner system according to any one of (1) to (9), wherein
   the imaging devices are capable to capture an optic flow; and
   the additional information comprises direction, speed, and acceleration of the optic flow.
(11) The scanner system according to any one of (1) to (10), wherein
   the additional information comprises a previously generated high resolution model of the three-dimensional shape of the object at rest; and
   the control unit is configured to reconstruct the three-dimensional shape of the object from the detected events with a spatial resolution that is lower than the spatial resolution of the high resolution model, and to fit the high resolution model to the three-dimensional shapes reconstructed from the detected events in order to increase the spatial resolution of these three-dimensional shapes.
(12) A method for operating a three-dimensional scanner system for reconstructing a three-dimensional shape of a moving object, the scanner system comprising a plurality of imaging devices each comprising a plurality of imaging pixels each of which being capable to detect a light intensity on the imaging pixel, and to detect as an event a positive or negative change of the light intensity that is larger than a respective predetermined threshold, the method comprising:
   detecting events with the plurality of imaging devices, while focusing the object with the imaging devices; and
   reconstructing a time series of the three-dimensional shape of the object based on the events detected by the imaging devices and on additional information about colors, shape and/or movements of the object.

1. A three-dimensional scanner system for reconstructing a three-dimensional shape of a moving object, the scanner system comprising:
a plurality of imaging devices each configured to be focused on the object and each comprising a plurality of imaging pixels each of which being capable to detect a light intensity on the imaging pixel, and to detect as an event a positive or negative change of the light intensity that is larger than a respective predetermined threshold; and
a control unit configured to control the plurality of imaging devices and to reconstruct a time series of the three-dimensional shape of the object based on the events detected by the imaging devices and on additional information about colors, shape and/or movements of the object.

2. The scanner system according to claim 1, wherein
the control unit is configured to generate for each imaging device a two-dimensional image showing the events detected by the respective imaging device during a predetermined time period, to extract key features from the two-dimensional images captured by all imaging devices during the predetermined time period, and to perform feature matching between the extracted key features, in order to reconstruct the three-dimensional shape the object had during the predetermined time period; and
the control unit is configured to use the additional information to support the process of feature matching.

3. The scanner system according to claim 1, further comprising
imaging devices that are capable to detect light intensities of visible light in different color channels in order to generate the additional information.

4. The scanner system according to claim 3, wherein
additional information is used to add color information on the three-dimensional shape reconstructed from the detected events.

5. The scanner system according to claim 3, wherein
the additional information comprises a time series of color frame images of the moving object; and
the control unit is configured to improve the time series of color frame images by removing blur from the color frame images or by interpolating the color frame images based on the detected events, and to reconstruct the time series of the three-dimensional shape of the object from the improved time series of color frame images.

6. The scanner system according to claim 1, wherein
the imaging pixels are capable to group the detected events according to characteristics of the received light; and
the additional information comprises information on the spatial and/or temporal distribution of events generated by light of a given characteristic.

7. The scanner system according to claim 6, wherein
the same imaging pixels are capable to detect events and to detect light intensities of different color channels; and
the given characteristic is the color of the received light.

8. The scanner system according to claim 6, wherein
the imaging pixels are capable to group the detected events according to the polarization of the received light; and
the given characteristics is the polarization of the received light.

9. The scanner system according to claim 1, wherein
the control unit is configured to deduce for each imaging device from changes in the distribution of detected events over time directions of movements of the object; and
the additional information comprises the directions of movements of the object as deduced for at least a part of the imaging devices.

10. The scanner system according to claim 1, wherein
the imaging devices are capable to capture an optic flow; and
the additional information comprises direction, speed, and acceleration of the optic flow.

11. The scanner system according to claim 1, wherein
the additional information comprises a previously generated high resolution model of the three-dimensional shape of the object at rest; and
the control unit is configured to reconstruct the three-dimensional shape of the object from the detected events with a spatial resolution that is lower than the spatial resolution of the high resolution model, and to fit the high resolution model to the three-dimensional shapes reconstructed from the detected events in order to increase the spatial resolution of these three-dimensional shapes.

12. A method for operating a three-dimensional scanner system for reconstructing a three-dimensional shape of a moving object, the scanner system comprising a plurality of imaging devices each comprising a plurality of imaging pixels each of which being capable to detect a light intensity on the imaging pixel, and to detect as an event a positive or negative change of the light intensity that is larger than a respective predetermined threshold, the method comprising:
detecting events with the plurality of imaging devices, while focusing the object with the imaging devices; and
reconstructing a time series of the three-dimensional shape of the object based on the events detected by the imaging devices and on additional information about colors, shape and/or movements of the object.
